(19) United States
(12) Patent Application Publication
(10) Pub. No.: US 2023/0059035 A1
(43) Pub. Date: Feb. 23, 2023

(54) EFFICIENT ENCODING OF FILM GRAIN NOISE

(71) Applicant: NETFLIX, INC., Los Gatos, CA (US)

(72) Inventors: Anush MOORTHY, Redwood City, CA (US); Andrey NORKIN, Campbell, CA (US)

(21) Appl. No.: 17/409,580

(22) Filed: Aug. 23, 2021

(51) Int. Cl. H04N 19/85; H04N 19/52; H04N 19/176; H04N 19/593; H04N 19/172; H04N 19/80; H04N 19/147

(52) U.S. Cl. CPC H04N 19/85; H04N 19/52; H04N 19/176; H04N 19/593; H04N 19/172; H04N 19/80; H04N 19/147

(57) ABSTRACT

One embodiment of the present invention sets forth a technique for encoding video frames. The technique includes performing one or more operations to generate a plurality of denoised video frames associated with a video sequence. The technique also includes determining a first set of motion vectors based on a first denoised frame included in the plurality of denoised video frames and a second denoised frame included in the plurality of denoised video frames, and determining a first residual between the second denoised frame and a prediction frame associated with the second denoised frame. The technique further includes performing one or more operations to generate an encoded video frame associated with the second denoised frame based on the first set of motion vectors, the first residual, and a first frame that is included in the video sequence and corresponds to the first denoised frame.

### BACKGROUND

### Field of the Various Embodiments

Embodiments of the present disclosure relate generally to video encoding and, more specifically, to efficient encoding of film grain noise.

### Description of the Related Art

Film grain is a random optical effect originally attributable to the presence of small particles of metallic silver, or dye clouds found on processed photographic film. During playback of a media title using video content that includes film grain, the film grain appears as imperfections that provide a distinctive “movie” look that is aesthetically valued by many producers and viewers of the video content. By contrast, during playback of a media title using video content that does not include film grain, the lack of the film grain “imperfections” often appears artificial. However, film grain is a type of noise and, because noise is less predictable than other video content, encoding noise is exceedingly inefficient. For this reason, video streaming service providers can remove noise, including film grain, from source video content prior to encoding. The resulting encoded, de-noised video content can then be transmitted to various client devices for playback. When those client devices receive and decode the encoded video content, the resulting decoded video content, which is used for playback of the media title, does not include film grain and therefore lacks the characteristic “movie” look.

To avoid the above issues and provide the aesthetically pleasing movie look during playback of a media title, some video streaming service providers or broadcasters implement a film grain modeling application that models film grain in source video content using a variety of film grain parameters. For each media title, the video streaming service provider or broadcaster transmits the film grain parameters along with the encoded video content to client devices. Each client device can implement a reconstruction application that synthesizes the film grain based on the film grain parameters. The reconstruction application combines the synthesized film grain with the decoded video content to generate reconstructed video content that is subsequently used for playback of the media title.

One problem, though, is that many video codecs do not support modeling or synthesis of film grain noise. Instead, these video codecs require any film grain noise that appears in a video to be encoded with the underlying video content. During a standard video encoding process, a current frame is compared with one or more reference frames using a motion estimation technique, and a block-based prediction of the current frame is generated by applying motion vectors produced via the motion estimation technique to one or more previous frames. A residual that represents the error in prediction also is computed as a difference between the current frame and the prediction. This residual is then block-transformed and quantized to produce a set of quantized transform coefficients that are entropy encoded and transmitted with entropy-coded motion vectors from the motion estimation step in a coded stream. During decoding and playback of the video from the coded stream, inverse quantization and an inverse block transform are applied to the quantized transform coefficients in the coded stream to produce a quantized residual. The quantized residual is then added to the prediction of the current frame to form a reconstructed frame. This reconstructed frame can then be outputted for display and/or used as a reference for prediction or reconstruction operations associated with other frames in the same video.

One drawback of encoding film grain noise via the above process is that, because film grain noise is temporally uncorrelated across consecutive video frames, encoding film grain noise usually increases the energy associated with the motion-compensated residual. Increases in energy are reflected in greater numbers of non-zero quantized coefficients in an encoded video, which causes the bitrate associated with the encoded video to increase. Alternatively, larger residual values can be quantized more heavily in the encoded video to avoid the increase in bitrate. However, heavily quantized residual values generally result in a coarse representation of the film grain noise, which can cause noticeable visual artifacts when reconstructing and playing back the encoded video.

As the foregoing illustrates, what is needed in the art are more effective techniques for encoding film grain noise in video frames.

### SUMMARY

One embodiment of the present invention sets forth a technique for encoding video frames. The technique includes performing one or more operations to generate a plurality of denoised video frames associated with a video sequence. The technique also includes determining a first set of motion vectors based on a first denoised frame included in the plurality of denoised video frames and a second denoised frame included in the plurality of denoised video frames, and determining a first residual between the second denoised frame and a prediction frame associated with the second denoised frame. The technique further includes performing one or more operations to generate an encoded video frame associated with the second denoised frame based on the first set of motion vectors, the first residual, and a first frame that is included in the video sequence and corresponds to the first denoised frame.

One technical advantage of the disclosed techniques relative to the prior art is that, with the disclosed techniques, film grain noise present in a video can be encoded without substantially increasing the bitrate or file size of the encoded video, since the residual and motion vector information is computed using the denoised frames. Further, because the encoded bitstream contains the representation of the original, non-denoised reference frame(s), the technique allows for a faithful reproduction of the original noise in the decoded video. Thus, with the disclosed techniques, fewer computational and storage resources are consumed when storing and streaming an encoded video relative to prior art approaches that encode the film grain noise along with the underlying video content. Another technical advantage of the disclosed techniques is a reduction in visual artifacts when reconstructing and playing back an encoded video, compared to prior art approaches that heavily quantize residual values in encoded video to avoid bitrate increases. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a computer system configured to implement one or more aspects of various embodiments.

FIG. 2 is a more detailed illustration of the filtering engine and encoding engine of FIG. 1, according to various embodiments.

FIG. 3 illustrates an exemplar technique for encoding video performed by the filtering engine and encoding engine of FIG. 1, according to various embodiments.

FIG. 4 sets forth a flow diagram of method steps for encoding film grain noise present in a video, according to various embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

Film grain refers to imperfections in video content that provide a distinctive “movie” look during playback of an associated media title. In relatively old movies, film grain is a random optical effect attributable to the presence of small particles of metallic silver, or dye clouds found on processed photographic film. In more recent video content associated with digital video production chains, film grain may be generated and added to video content to avoid an artificially “smooth” look during playback of an associated media title. In general, the movie look attributable to film grain in video content is aesthetically valued by many producers and viewers of the video content.

However, film grain is a type of noise and because noise is unpredictable, encoding noise is inherently inefficient. Further, encoding source video content that includes film grain may partially remove and distort the film grain. For this reason, many video streaming service providers can remove noise, including film grain, from source video content prior to encoding the resulting de-noised video content for transmission to various client devices for playback. The resulting encoded, de-noised video content can then be transmitted to various client devices for playback. When those client devices receive and decode the encoded video content, the resulting decoded video content, which is used for playback of the media title, does not include film grain.

To enable those client devices to provide the aesthetically pleasing movie look during playback of the media title, some video streaming service providers implement a film grain modeling application. The film grain modeling application generates a variety of film grain parameters that model film grain in source video content. For each media title, the video streaming service provider transmits the film grain parameters along with the encoded video content to client devices. Each client device can implement a reconstruction application that synthesizes the film grain based on the film grain parameters. The reconstruction application combines the synthesized film grain with the decoded video content to generate reconstructed video content that is subsequently used for playback of the media title.

However, many legacy video codecs do not support modeling or reconstruction of film grain noise. Thus, film grain noise in videos that utilize these legacy video codecs must be encoded with the underlying video content for the film grain to appear during subsequent decoding and playback of the videos. Further, the lack of spatial and temporal correlation in the film grain prevents these legacy video codecs from efficiently encoding the film grain, which can cause significant increases in the bitrate and/or file sizes of the encoded video. Conversely, enforcing bitrate constraints on the encoded video can result in a coarse film grain representation and noticeable artifacts in the reconstructed video.

To improve the efficiency with which film grain noise in a video is encoded, a low-pass filter, linear filter (e.g., finite impulse response (FIR) filter, infinite impulse response (IIR) filter, etc.), non-linear filter, content-adaptive filter, temporal filter, and/or another type of filter is applied to some or all frames of the video to produce denoised versions of the frames. To encode a current frame (e.g., a P-frame or a B-frame) as a prediction from one or more reference frames (e.g., a reconstruction of a frame that precedes the current frame and/or a reconstruction of a frame that follows the current frame), motion vectors from a denoised version of each reference frame to a denoised version of the current frame are determined, and a residual is computed as a difference between the current frame and a prediction of the current frame that is generated by applying the motion vectors to the reference frame.

The encoding of the current frame can then be generated based on the motion vectors, the residual, and encoded frames used to reconstruct the reference frame(s). For example, the encoding of the current frame could include quantized transform coefficients that represent the residual between the denoised current frame and each denoised reference frame, encoded motion vectors between the denoised current frame and each denoised reference frame, and a reference to an encoded frame used to reconstruct the reference frame. When the current frame is decoded, the current frame is predicted from the noisy reference frame(s) and thus includes film grain noise from the noisy reference frame(s). On the other hand, a lack of film grain noise in the residual prevents an increase in bitrate associated with encoding film grain noise in motion-compensated residual signals.

The disclosed techniques additionally encode film grain noise on a selective basis to avoid noticeable artifacts and/or reductions in visual quality. First, a motion vector of 0 between two or more frames can cause a “dirty window” effect, in which stationary film grain noise in the frames appears to be superimposed on the video content in the frames. To avoid this dirty window effect, a small random or pseudo-random offset may be added to a motion vector of 0 between a reference frame and a current frame. Alternatively or additionally, the film grain noise in the portion of the current frame that is associated with the zero-valued motion vector may be encoded in the residual to capture movement in the film grain noise across frames.

Second, the disclosed techniques perform intra-frame prediction using reconstructed frames that include film grain noise instead of the corresponding denoised frames from which motion vectors and/or residuals in the encoded video are computed. This approach encodes film grain noise in the intra-frame predicted blocks while avoiding artifacts and/or distortions that can be caused by performing intra-frame prediction of a block from neighboring blocks in a denoised frame and subsequently reconstructing the block from noisy blocks in a corresponding reconstruction of the frame.

Alternatively, when the video codec includes an intra-block copy (IBC) tool that copies a previously encoded block to an intra-frame predicted block in the same frame, the offset and residual between the previously encoded block and the intra-frame predicted block may be computed using a denoised version of the frame. During subsequent decoding of the encoded frame, blocks in a reconstruction of the frame that are not intra-frame predicted include film grain noise from the original noisy frame and/or a reconstruction of the frame from a noisy reference frame. Thus, any intra-frame predicted blocks in the reconstruction of the current frame also include noise that is copied from the other blocks in the reconstructed frame.

One technical advantage of the disclosed techniques relative to the prior art is that, with the disclosed techniques, film grain noise present in a video can be encoded without substantially increasing the bitrate or file size of the encoded video, since the residual and motion vector information is computed using the denoised frames. Further, because the encoded bitstream contains the representation of the original, non-denoised reference frame(s), the technique allows for a faithful reproduction of the original noise in the decoded video. Thus, with the disclosed techniques, fewer computational and storage resources are consumed when storing and streaming an encoded video relative to prior art approaches that encode the film grain noise along with the underlying video content. Another technical advantage of the disclosed techniques is a reduction in visual artifacts when reconstructing and playing back an encoded video, compared to prior art approaches that heavily quantize residual values in encoded video to avoid bitrate increases. These technical advantages provide one or more technological advancements over prior art approaches.

### System Overview

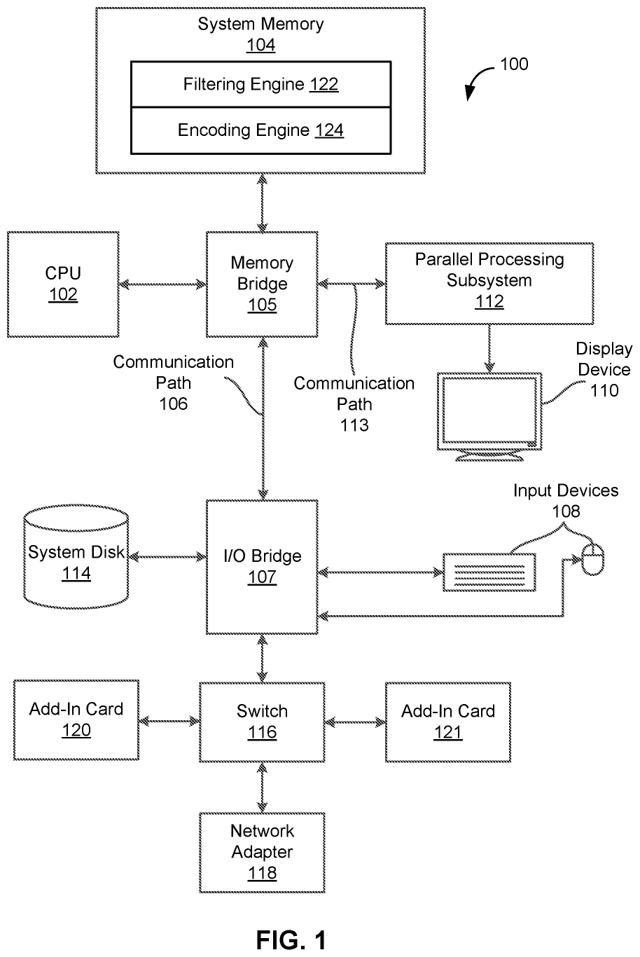

FIG. 1 is a block diagram illustrating a computer system 100 configured to implement one or more aspects of various embodiments. In some embodiments, computer system 100 is a machine or processing node operating in a data center, cluster, or cloud computing environment that provides scalable computing resources (optionally as a service) over a network.

As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

I/O bridge 107 is configured to receive user input information from optional input devices 108, such as a keyboard or a mouse, and forward the input information to CPU 102 for processing via communication path 106 and memory bridge 105. In some embodiments, computer system 100 may be a server machine in a cloud computing environment. In such embodiments, computer system 100 may not have input devices 108. Instead, computer system 100 may receive equivalent input information by receiving commands in the form of messages transmitted over a network and received via the network adapter 118. In one embodiment, switch 116 is configured to provide connections between I/O bridge 107 and other components of the computer system 100, such as a network adapter 118 and various add-in cards 120 and 121.

In one embodiment, I/O bridge 107 is coupled to a system disk 114 that may be configured to store content and applications and data for use by CPU 102 and parallel processing subsystem 112. In one embodiment, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

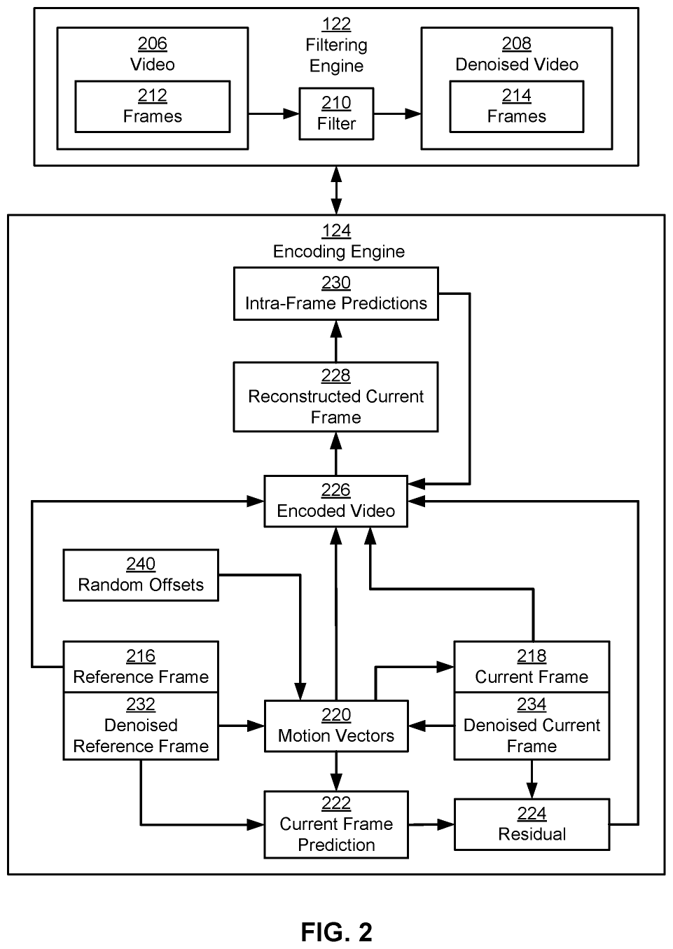

In some embodiments, parallel processing subsystem 112 includes a graphics subsystem that delivers pixels to an optional display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in conjunction with FIG. 2, such circuitry may be incorporated across one or more parallel processing units (PPUs), also referred to herein as parallel processors, included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver configured to manage the processing operations of the one or more PPUs within parallel processing subsystem 112.

Parallel processing subsystem 112 may be integrated with one or more of the other elements of FIG. 1 to form a single system. For example, parallel processing subsystem 112 may be integrated with CPU 102 and other connection circuitry on a single chip to form a system on chip (SoC).

In one embodiment, CPU 102 is the master processor of computer system 100, controlling and coordinating operations of other system components. In one embodiment, CPU 102 issues commands that control the operation of PPUs. In some embodiments, communication path 113 is a PCI Express link, in which dedicated lanes are allocated to each PPU, as is known in the art. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. First, the functionality of the system can be distributed across multiple nodes of a distributed and/or cloud computing system. Second, the connection topology, including the number and arrangement of bridges, the number of CPUs 102, and the number of parallel processing subsystems 112, can be modified as desired. For example, in some embodiments, system memory 104 could be connected to CPU 102 directly rather than through memory bridge 105, and other devices would communicate with system memory 104 via memory bridge 105 and CPU 102. In another example, parallel processing subsystem 112 may be connected to I/O bridge 107 or directly to CPU 102, rather than to memory bridge 105. In a third example, I/O bridge 107 and memory bridge 105 may be integrated into a single chip instead of existing as one or more discrete devices. Third one or more components shown in FIG. 1 may not be present. For example, switch 116 could be eliminated, and network adapter 118 and add-in cards 120, 121 would connect directly to I/O bridge 107.

In one or more embodiments, computer system 100 is configured to execute a filtering engine 122 and an encoding engine 124 that reside in system memory 104. Filtering engine 122 and encoding engine 124 may be stored in system disk 114 and/or other storage and loaded into system memory 104 when executed.

More specifically, filtering engine 122 applies one or more filters to video content to generate denoised versions of video frames in the video content. The denoised versions of the video frames lack some or all film grain noise in the original video content. Encoding engine 124 then uses denoised versions of a reference frame and a current frame to be predicted from the reference frame to compute motion vectors and a residual between the reference frame and the current frame. Encoding engine 124 further generates an encoding of the current frame using the motion vectors, residual, and a reconstruction of the original (noisy) reference frame. As described in further detail below, this technique for encoding video frames allows film grain to appear in the current frame by copying the film grain from the reference frame into the current frame. At the same time, the film grain in the current frame is not captured in the residual, thereby mitigating the increase in bitrate or file size associated with encoding film grain noise in the current frame.

### Efficient Encoding of Film Grain Noise

FIG. 2 is a more detailed illustration of functionality provided by filtering engine 122 and encoding engine 124 of FIG. 1, according to various embodiments. As shown in FIG. 2, filtering engine 122 applies a filter 210 to frames 212 of video 206 to produce corresponding frames 214 of denoised video 208. For example, filtering engine 122 could apply a low-pass, nonlinear, content-adaptive, temporal, and/or another type of filter 210 to frames 212 to produce corresponding frames 214 that lack some or all film grain noise that is found in frames 212. The operation of filtering engine 122 may optionally be tuned to allow a certain level or type of noise to be included in the filtered frames 214 while removing other noise from the filtered frames 214.

Next, encoding engine 124 uses frames 214 of denoised video 208 and corresponding frames 212 of video 206 to generate encoded video 226. For example, encoding engine 124 could use one or more video coding formats and/or codecs to generate encoded video 226 from frames 212 and/or frames 214. Encoded video 226 could then be stored on a server, a computing device, cloud storage, a hard disk drive, a solid-state drive, optical media, and/or another type of storage medium. Encoded video 226 could also, or instead, be transmitted or streamed over a network (e.g., a wide area network (WAN), local area network (LAN), personal area network (PAN), WiFi network, cellular network, Ethernet network, Bluetooth network, universal serial bus (USB) network, satellite network, the Internet, etc.) for decoding and/or playback on an endpoint device (e.g., a personal computer, laptop computer, game console, smartphone, tablet computer, digital video recorder, media streaming device, etc.).

During generation of encoded video 226, encoding engine 124 encodes a current frame 218 (e.g., a P-frame or a B-frame) as a prediction from a reference frame 216 (e.g., a frame that precedes or follows current frame 218). In some embodiments, encoding engine 124 obtains reference frame 216 as a reconstruction of a key frame in video 206 from which current frame 218 is to be predicted. Encoding engine 124 also obtains current frame 218 as a frame that precedes or follows the key frame within video 206. Encoding engine 124 further obtains denoised reference frame 232 from filtering engine 122 as a denoised version of reference frame 216 (e.g., after filtering engine 122 applies filter 210 to reference frame 216). Encoding engine 124 similarly obtains denoised current frame 234 from filtering engine 122 as a denoised version of current frame 218 (e.g., after filtering engine 122 applies filter 210 to current frame 218).

In one or more embodiments, encoding engine 124 computes motion vectors 220 and a residual 224 from denoised reference frame 232 to denoised current frame 234. More specifically, encoding engine 124 uses a motion estimation technique to compute motion vectors 220 from blocks of denoised reference frame 232 to locations in denoised current frame 234. Encoding engine 124 then applies motion vectors 220 to denoised reference frame 232 to produce a current frame prediction 222 and computes residual 224 as a difference between current frame prediction 222 and denoise current frame 234.

Encoding engine 124 then uses motion vectors 220, residual 224, and the original (noisy) reference frame 216 to generate an encoding of current frame 218 within encoded video 226. For example, encoding engine 124 could include, in the encoding of current frame 218, quantized transform coefficients that can be used to recreate residual 224 between denoised current frame 234 and denoised reference frame 232, motion vectors 220 between from denoised reference frame 232 to denoised current frame 234, and a reference to an encoded version of reference frame 216 within encoded video 226.

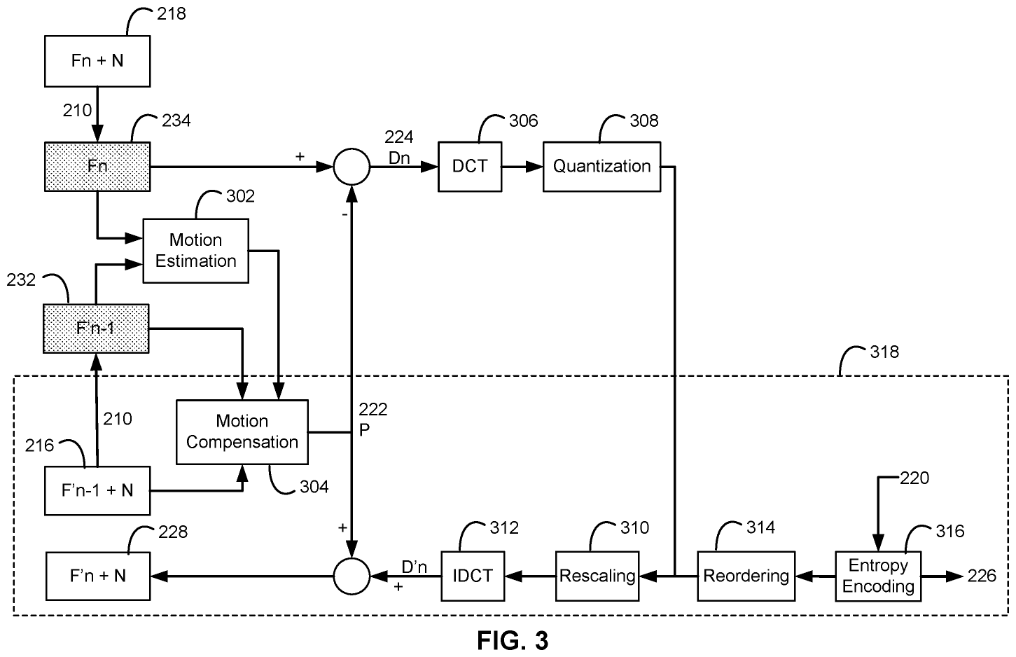

Encoding engine 124 additionally includes functionality to generate a reconstructed current frame 228 from encoded video 226. Continuing with the above example, encoding engine 124 could include a decoder path that converts quantized transform coefficients in encoded video 226 into a quantized residual 224, applies motion vectors 220 to a reconstruction of reference frame 216 to produce blocks in reconstructed current frame 228, and adds residual 224 to the blocks in reconstructed current frame 228. Encoding engine 124 could then use reconstructed current frame 228 as a new reference frame 216 for further encoding and/or reconstruction of a corresponding current frame 218 (e.g., the next frame in encoded video 226 that is predicted using reconstructed current frame 228). The operation of encoding engine 124 in encoding and/or decoding a given current frame 218 from a corresponding reference frame 216 is described in further detail below with respect to FIG. 3.

Because reconstructed current frame 228 is generated from the noisy reference frame 216, reconstructed reference frame 228 includes film grain noise that is copied from the noisy reference frame 216. At the same time, encoding engine 124 avoids an increase in bitrate associated with encoding film grain noise in motion-compensated residual signals by generating residual 224 from denoised reference frame 232 and denoised current frame 234.

In one or more embodiments, encoding engine 124 generates intra-frame predictions 230 in encoded video 226 from a corresponding reconstructed current frame 228 that includes film grain noise instead of a corresponding denoised current frame 234. For example, encoding engine 124 could perform intra-frame coding of a given frame in video 206 by computing intra-frame predictions 230 of pixel values in a block within the frame as extrapolations of pixel values in noisy blocks that are directly above, above and to the left, above and to the right, and/or to the left of the block in reconstructed current frame 228. In doing so, encoding engine 124 encodes film grain noise in the intra-frame predicted blocks while avoiding artifacts and/or distortions caused by intra-frame prediction of a block from neighboring blocks in denoised current frame 234 and subsequently reconstructing the block from noisy blocks in reconstructed current frame 228.

In addition to encoding intra-frames containing the film grain noise, encoding engine 124 can selectively encode certain inter-predicted frames or parts of the inter-predicted frames using original non-filtered frames with film grain. These inter-predicted frames or portions of inter-predicted frames can be used as reference frames that contain original film grain, which can improve the visual quality of additional frames predicted using the reference frames.

Alternatively, when the video codec used by encoding engine 124 to generate encoded video 226 includes an intra-block copy (IBC) tool that copies a previously encoded block to an intra-frame predicted block in a given current frame 218, encoding engine 124 may compute the offset (or motion vector) and residual between the previously encoded block and the intra-frame predicted block using a corresponding denoised current frame 234. During decoding of encoded video 226 into reconstructed current frame 228, non-intra-frame predicted blocks in reconstructed current frame 228 include film grain noise from the original current frame 218 and/or a reconstruction of current frame 218 from a noisy reference frame 216. Thus, any intra-frame predicted blocks in reconstructed current frame 228 also include noise that is copied from the non-intra-frame predicted blocks and/or from reconstructed intra-frame predicted blocks.

Those skilled in the art will appreciate that a zero-valued motion vector between two or more consecutive frames in encoded video 226 can cause a “dirty window” effect, in which stationary film grain noise in the frames appears to be superimposed on the video content in the frames. A similar issue can occur when motion vectors for multiple adjacent blocks have a fixed value (e.g., if the blocks use the same motion vector valued (m, n) to track the motion of an object). To avoid this dirty window effect, encoding engine 124 may add a small random or pseudo-random offset (e.g., random offsets 240) to zero-valued or fixed-valued motion vectors 220 and subsequently calculate residual 224 based on the updated motion vectors 220. Alternatively, encoding engine 124 may keep the zero- or fixed-valued motion vectors 220 and encode, in residual 224, film grain noise in portions of a given current frame 218 that are associated with the zero- or fixed-valued motion vectors 220 to capture movement in the film grain noise across frames.

In some embodiments, encoding engine 124 generates motion vectors 220 and residual 224 values in encoded video 226 based on a rate-distortion optimization (RDO) process. During the RDO process, encoding engine 124 calculates the cost of a block using the following formula:

cost=distortion+λ*bitrate (1)

In the above formula, the cost is calculated as a sum of the distortion associated with encoding the block and the product of the bitrate of the encoded block multiplied by a parameter λ. λ can be adjusted to balance between different modes or techniques for generating encoded video 226 from reference frame 216, current frame 218, denoised reference frame 232, and/or denoised current frame 234. During generation of encoded video 226, encoding engine 124 uses Equation 1 to evaluate the cost associated with different techniques for encoding a frame of video 206 and/or one or more blocks within the frame. Encoding engine 124 then uses the technique associated with the lowest cost to encode the frame and/or block(s) within encoded video 226.

First, encoding engine 124 can use RDO to balance inter-frame prediction and intra-frame prediction of blocks in encoded video 226. For example, encoding engine 124 could use Equation 1 to calculate the cost associated with a block that is inter-frame predicted, intra-frame predicted, and/or intra-frame predicted using IBC. Encoding engine 124 then selects the encoding technique associated with the lowest cost for use in encoding the block in encoded video 226. To achieve a certain balance between inter-frame prediction and intra-frame prediction of blocks in encoded video 226, encoding engine 124 could apply a multiplicative factor to the cost for a given encoding technique and/or use a different value of λ in calculating the cost for each encoding technique.

Second, encoding engine 124 can use RDO to select between multi-frame or single-frame inter-prediction of a given current frame 218. For example, encoding engine 124 could use Equation 1 to calculate the cost associated with inter-frame prediction of current frame 218 from a single reference frame 216 (e.g., a frame that immediately precedes current frame 218) and the cost of inter-frame prediction of current frame 218 from multiple reference frames (e.g., two frames that immediately precede and immediately follow current frame 218). When inter-frame prediction of current frame 218 from a single reference frame 216 is associated with a lower cost, encoding engine 124 uses reference frame 216, a corresponding denoised reference frame 232, current frame 218, and a corresponding denoised current frame 234 to generate an encoding of current frame 218. When multi-frame prediction is associated with a lower cost, encoding engine 124 uses two reference frames, two corresponding denoised reference frames, current frame 218, and a corresponding denoised current frame 234 to generate an encoding of current frame 218.

Third, encoding engine 124 can use RDO to select between different techniques for addressing the dirty window effect. For example, encoding engine 124 could use Equation 1 to calculate the cost of adding random offsets 240 to zero- or fixed-value motion vectors 220 from denoised reference frame 232 to denoised current frame 234 and the cost of keeping a zero- or fixed-valued motion vector and encoding film grain noise in residual 224. Encoding engine 124 may then select the technique associated with the lower cost to encode blocks associated with the dirty window effect. In another example, encoding engine 124 could adjust the value of λ in Equation 1 to address the dirty window effect. A lower value of λ would increase the contribution of block distortion to the cost and thus reduce the likelihood that zero- or fixed-value motion vectors 220 are calculated for adjacent blocks. A higher value of λ would increase the contribution of bitrate to the to the cost and result in a balance between adding random offsets 240 to zero- or fixed-value motion vectors 220 and encoding film grain in residual 124 after keeping the zero- or fixed-value motion vectors 220.

Those skilled in the art will appreciate that encoding engine 124 may use and/or combine encoding techniques in other ways. For example, encoding engine 124 could generate an encoding of current frame 218 that includes motion vectors from blocks in multiple reference frames that precede and/or follow current frame 218 to locations in current frame 218. In another example, encoding engine 124 could generate an encoding of current frame 218 that includes a weighted sum of inter-frame predictions and intra-frame predictions 230. In a third example, encoding engine 124 could select one or more of the above techniques for predicting current frame 218 (e.g., uni-directional inter-frame prediction, bi-directional inter-frame prediction, inter-frame prediction from multiple reference frames, intra-frame prediction, etc.) based on one or more characteristics of film grain noise and/or video content in current frame 218, in lieu of or in addition to using RDO to select between or among the techniques.

FIG. 3 illustrates an exemplar technique for encoding video performed by filtering engine 122 and encoding engine 124 of FIG. 1, according to various embodiments. As shown in FIG. 3, reference frame 216 is denoted by “F′n−1+N,” current frame 218 is denoted by “Fn+N,” denoised reference frame 232 is denoted by “F′n−1,” and denoised current frame 234 is denoted by “Fn.” Thus, “N” represents the noise component of reference frame 216 and current frame 218. This noise component is filtered from reference frame 216 and current frame 218 (e.g., by filtering engine 122) to produce denoised reference frame 232 and denoised current frame 234, respectively.

During encoding of current frame 218, encoding engine 124 uses motion estimation 302 to compute motion vectors 220 between denoised reference frame 232 and denoised current frame 234. For example, encoding engine 124 could use block matching, phase correlation, pixel recursive, optical flow, and/or other motion estimation 302 techniques to generate motion vectors 220 that represent estimates of motion from blocks in denoised reference frame 232 to denoised current frame 234. When one or more motion vectors 220 are zero-valued and/or have fixed values for a group of adjacent blocks, encoding engine 124 optionally adds a small random or pseudo-random offset to each zero- and/or fixed-valued motion vector to avoid the “dirty window” effect associated with stationary film grain noise across frames of video.

Next, encoding engine 124 uses motion compensation 304 to generate current frame prediction 222 (denoted by “P” in FIG. 3) from denoised reference frame 232 and motion vectors 220. For example, encoding engine 124 could displace blocks in denoised reference frame 232 by the corresponding motion vectors 220 to produce current frame prediction 222.

Encoding engine 124 also calculates residual 224 (denoted by “Dn” in FIG. 3) as a difference between denoised current frame 234 and current frame prediction 222. For example, encoding engine 124 could compute residual 224 by subtracting current frame prediction 222 from denoised current frame 234.

After residual 224 is computed, encoding engine 124 applies a discrete cosine transform (DCT) 306 and quantization 308 to residual 224 to produce a set of quantized transform coefficients representing residual 224. Encoding engine 124 also performs entropy encoding 316 of the quantized transform coefficients, motion vectors 220, and associated headers and includes the entropy encoded data in encoded video 226. For example, encoding engine 124 could convert the quantized transform coefficients, motion vectors 220, and headers for blocks in the encoded current frame 218 into a series of bits generated by an entropy encoding scheme, such as (but not limited to) variable length codes (VLCs) and/or arithmetic coding. Encoding engine 124 could then store the VLCs in one or more files of encoded video 226 and/or transmit the VLCs in a coded stream representing encoded video 226.

Encoding engine 124 further includes, in encoded video 226, an encoding of reference frame 216 and an indication that reference frame 216 is the key frame from which current frame 218 is to be reconstructed. Thus, current frame 218 is decoded by applying motion vectors 220 and residual 224 to a reconstruction of an encoded noisy video frame.

Encoding engine 124 also includes a decoder path 318 that generates reconstructed current frame 228 (denoted by “F′n+N” in FIG. 3) from encoded video 226. As shown in FIG. 3, the decoder path performs reordering 314 of temporally out-of-order encoded frames in encoded video 226, followed by rescaling 310 (Le., inverse quantization) and an inverse DCT (IDCT) 312 to produce a quantized residual (denoted by “D′n” in FIG. 3). Decoder path 318 also generates a different current frame prediction 222 by performing motion compensation 304 that displaces blocks in reference frame 216 by the corresponding motion vectors 220. Decoder path 318 then adds the quantized residual to current frame prediction 222 to form reconstructed current frame 228. As discussed above, reconstructed current frame 228 can then be used as a new reference frame 216 from which a corresponding current frame 218 is predicted and encoded. Some blocks in reconstructed current frame 228 can also, or instead, be used to perform intra-frame prediction of other blocks in current frame 234. These intra-frame predicted blocks can then be used to update the encoding of current frame 234 in encoded video 226.

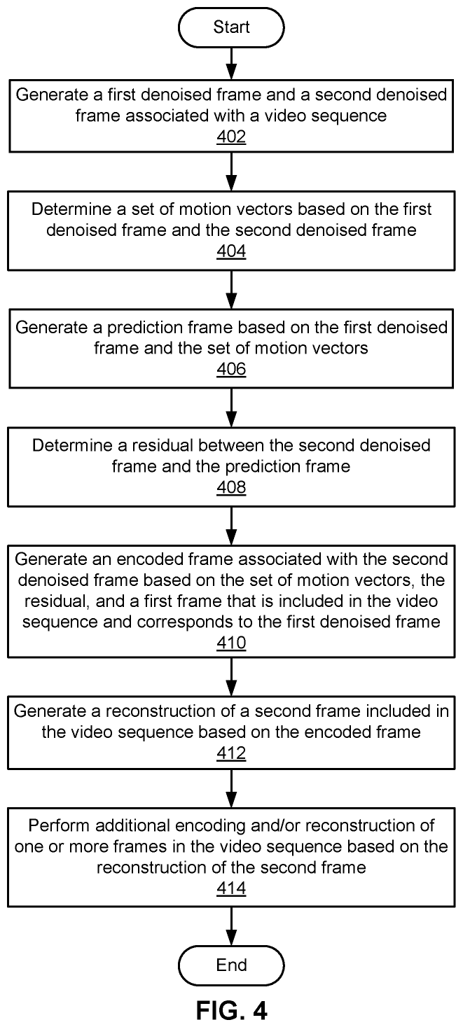

FIG. 4 sets forth a flow diagram of method steps for encoding film grain noise present in a video, according to various embodiments. Although the method steps are described in conjunction with the systems of FIGS. 1-3, persons skilled in the art will understand that any system configured to perform the method steps in any order falls within the scope of the present disclosure.

As shown, filtering engine 122 generates 402 a first denoised frame and a second denoised frame associated with a video sequence. More specifically, filtering engine 122 applies one or more filters to a reconstruction of a first frame in the video sequence (e.g., from an encoding of the first frame) to produce a first denoised frame. Filtering engine 122 also applies the filter(s) to a second frame that is adjacent to the first frame in the video sequence to produce a second denoised frame.

Next, encoding engine 124 determines 404 a set of motion vectors based on the first denoised frame and the second denoised frame. For example, encoding engine 124 could use one or more motion estimation techniques to calculate motion vectors from the first denoised frame to the second denoised frame.

Encoding engine 124 also generates 406 a prediction frame based on the first denoised frame and the set of motion vectors. For example, encoding engine 124 could generate the prediction frame by displacing blocks in the first denoised frame by the corresponding motion vectors.

Encoding engine 124 further determines 408 a residual between the second denoised frame and the prediction frame. For example, encoding engine 124 could compute the residual as a difference between the prediction frame and the second denoised frame.

Encoding engine 124 then generates 410 an encoded video frame associated with the second denoised frame based on the set of motion vectors, the residual, and the first frame that is included in the video sequence and corresponds to the first denoised frame. For example, encoding engine 124 could apply a DCT and quantization to the residual to produce a set of quantized transform coefficients. Encoding engine 124 could also perform entropy encoding of the quantized transform coefficients, motion vectors, and associated headers and include the entropy encoded data in the encoded video frame. Encoding engine 124 could additionally add, to the encoded video frame, a reference to an encoding of the first frame to indicate that the encoded video frame is to be reconstructed from the encoding of the first frame.

Encoding engine 124 additionally generates 412 a reconstruction of the second frame based on the encoded frame. Continuing with the above example, encoding engine 124 could apply rescaling and an inverse DCT to the quantized transform coefficients to generate a quantized residual. Encoding engine 124 could also decode the motion vectors in the encoded frame and generate a new prediction frame by displacing blocks in the reconstruction of the first frame by the corresponding motion vectors. Encoding engine 124 could then add the quantized residual to the new prediction to form the reconstruction of the second frame.

Encoding engine 124 performs 414 additional encoding and/or reconstruction of one or more frames in the video sequence based on the reconstruction of the second frame. For example, encoding engine 124 could use the reconstruction of the second frame as a reference frame from which a third frame in the video sequence is predicted and encoded. In another example, encoding engine 124 could use some blocks in the reconstruction to perform intra-frame prediction of other blocks in the second frame. These intra-frame predicted blocks can then be used to update the encoded video frame representing the second frame.

During operations 404-414, encoding engine 124 uses RDO and/or one or more encoding techniques to generate one or more encoded frames. As discussed above, encoding engine 124 can use multiple techniques to encode one or more blocks in the encoded frame. These techniques include (but are not limited to) performing inter-frame prediction of a block in a frame to be encoded from one or more reference frames, performing intra-frame prediction of a block in the frame from one or more blocks in the same frame, adding a random offset of a zero-valued motion vector or a motion vector that is the same for a group of adjacent blocks, and/or encoding film grain noise in a block associated with a zero-valued or fixed-valued motion vector in a corresponding residual. Encoding engine 124 may calculate a cost associated with each technique and/or a combination of two or more techniques based on the distortion and bitrate associated with the corresponding encoded block. Finally, encoding engine 124 may encode the block using a technique and/or combination of techniques that is associated with the lowest cost.

In sum, the disclosed techniques perform efficient encoding of film grain noise in a video. A low-pass filter, linear filter (e.g., finite impulse response (FIR) filter, infinite impulse response (I IR) filter, etc.), non-linear filter, content-adaptive filter, temporal filter, and/or another type of filter are applied to some or all frames of the video to produce denoised versions of the frames. When a current frame (e.g., a P-frame or a B-frame) is to be encoded as a prediction from one or more reference frames (e.g., a reconstruction of one or more encoded frames that precede and/or follow the current frame), motion vectors from a denoised version of each reference frame to a denoised version of the current frame are determined, and a residual is computed as a difference between the denoised version of the current frame and a prediction of the current frame that is generated by applying the motion vectors to the denoised version of the reference frame.

The current frame can then be encoded based on the motion vectors, the residual, and encoded frames used to reconstruct the reference frame(s). For example, the encoding of the video could include an encoding of a frame from which a reference frame for the current frame is reconstructed instead of the denoised version of the reference frame. Within the encoding of the video, the encoding of the current frame could include quantized transform coefficients that can be used to recreate a residual between the current frame and each reference frame, motion vectors between the current frame and each reference frame, and a reference to an encoded frame used to reconstruct the reference frame. When the current frame is decoded, the current frame is predicted from the reference frame(s) and thus includes film grain noise from the reconstructed reference frame(s). On the other hand, the residual used to reconstruct the current frame lacks film grain noise, thereby preventing an increase in bitrate associated with encoding film grain noise in motion-compensated residual signals.

When a zero-valued motion vector is calculated between a reference frame and the current frame, a “dirty window” effect can occur, in which stationary film grain noise in the frames appears to be superimposed on the video content in the frames. To avoid this dirty window effect, a small random offset may be added to the zero-valued motion vector. Alternatively or additionally, the film grain noise in the portion of the current frame that is associated with the zero-valued motion vector may be encoded in the residual to capture movement in the film grain noise across frames.

When an encoding of a frame includes intra-frame prediction of one or more blocks within the frame, the disclosed techniques perform the intra-frame prediction using a reconstruction of the frame that include film grain noise instead of a corresponding denoised frame from which motion vectors and/or residuals in the encoding of the frame are computed. This approach avoids artifacts and/or distortions that can be caused by intra-frame prediction of a block from neighboring blocks in a denoised frame and subsequently reconstructing the block from noisy blocks in a reconstruction of the frame or from a noisy reference frame.

Alternatively, when the video codec includes an intra-block copy (IBC) tool that copies a previously encoded block to an intra-frame predicted block in the same frame, the offset and residual between the previously encoded block and the intra-frame predicted block may be computed using a denoised version of the frame. During subsequent decoding of the encoded frame, non-intra-frame predicted blocks in a reconstruction of the frame include film grain noise from an encoding of the noisy frame and/or a reconstruction of the frame from a noisy reference frame. Thus, any intra-frame predicted blocks in the reconstruction of the current frame also include film grain noise that is copied from the non-intra-frame predicted blocks.

One technical advantage of the disclosed techniques relative to the prior art is that, with the disclosed techniques, film grain noise present in a video can be encoded without substantially increasing the bitrate or file size of the encoded video, since the residual and motion vector information is computed using the denoised frames. Further, because the encoded bitstream contains the representation of the original, non-denoised reference frame(s), the technique allows for a faithful reproduction of the original noise in the decoded video. Thus, with the disclosed techniques, fewer computational and storage resources are consumed when storing and streaming an encoded video relative to prior art approaches that encode the film grain noise along with the underlying video content. Another technical advantage of the disclosed techniques is a reduction in visual artifacts when reconstructing and playing back an encoded video, compared to prior art approaches that heavily quantize residual values in encoded video to avoid bitrate increases. These technical advantages provide one or more technological advancements over prior art approaches.

1. In some embodiments, a computer-implemented method for encoding video frames comprises performing one or more operations to generate a plurality of denoised video frames associated with a video sequence, determining a first set of motion vectors based on a first denoised frame included in the plurality of denoised video frames and a second denoised frame included in the plurality of denoised video frames, determining a first residual between the second denoised frame and a prediction frame associated with the second denoised frame, and performing one or more operations to generate an encoded video frame associated with the second denoised frame based on the first set of motion vectors, the first residual, and a first frame that is included in the video sequence and corresponds to the first denoised frame.

2. The computer-implemented method of clause 1, further comprising generating a first reconstructed video frame associated with a second frame that is included in the video sequence and corresponds to the second denoised frame based on the first set of motion vectors, the first residual, and the first frame.

3. The computer-implemented method of clauses 1 or 2, further comprising generating a second reconstructed video frame associated with a third frame that is included in the video sequence based on the first reconstructed video frame, a second set of motion vectors, and a second residual.

4. The computer-implemented method of any of clauses 1-3, wherein performing the one or more operations to generate the encoded video frame comprises generating an intra-frame prediction of a block included in the encoded video frame based on one or more adjacent blocks included in the first reconstructed video frame.

5. The computer-implemented method of any of clauses 1-4, wherein performing the one or more operations to generate the encoded video frame comprises generating an intra-frame prediction of a block included in the encoded video frame based on a first cost associated with the intra-frame prediction and a second cost associated with an inter-frame prediction of the block.

6. The computer-implemented method of any of clauses 1-5, wherein performing the one or more operations to generate the encoded video frame comprises adding a random or pseudo-random offset to a zero-valued motion vector defined from a first denoised block included in the first denoised frame to a second denoised block included in the second denoised frame.

7. The computer-implemented method of any of clauses 1-6, wherein the first set of motion vectors includes a zero-valued motion vector defined from a first denoised block included in the first denoised frame to a second denoised block included in the second denoised frame, and further comprising performing one or more operations to generate the encoded video frame based on a second residual between a first block that corresponds to the first denoised block and is included in the first frame and a second block that corresponds to the second denoised block and is included in a second frame that corresponds to the second denoised frame.

8. The computer-implemented method of any of clauses 1-7, further comprising generating the prediction frame based on the first denoised frame and the first set of motion vectors.

9. The computer-implemented method of any of clauses 1-8, wherein performing the one or more operations to generate the plurality of denoised video frames comprises applying one or more filters to a first reconstructed frame associated with the first frame to generate the first denoised frame, and applying the one or more filters to a second frame that is adjacent to the first frame within the video sequence to generate the second denoised frame.

10. The computer-implemented method of any of clauses 1-9, wherein the one or more filters comprise at least one of a low-pass filter, a finite impulse response (FIR) filter, an infinite impulse response (IIR) filter, a nonlinear filter, a content-adaptive filter, or a temporal filter.

11. In some embodiments, one or more non-transitory computer readable media store instructions that, when executed by one or more processors, cause the one or more processors to perform the steps of performing one or more operations to generate a plurality of denoised video frames associated with a video sequence, determining a first set of motion vectors based on a first denoised frame included in the plurality of denoised video frames and a second denoised frame included in the plurality of denoised video frames, generating a prediction frame based on the first denoised frame and the first set of motion vectors, determining a first residual between the second denoised frame and the prediction frame, and performing one or more operations to generate an encoded video frame associated with the second denoised frame based on the first set of motion vectors, the first residual, and a first frame that is included in the video sequence and corresponds to the first denoised frame.

12. The one or more non-transitory computer readable media of clause 11, wherein the instructions further cause the one or more processors to perform the step of generating a first reconstructed video frame associated with a second frame that is included in the video sequence and corresponds to the second denoised frame based on the first set of motion vectors, the first residual, and the first frame.

13. The one or more non-transitory computer readable media of clauses 11 or 12, wherein the instructions further cause the one or more processors to perform the step of generating an intra-frame prediction of a block included in the encoded video frame based on one or more adjacent blocks included in the second denoised frame.

14. The one or more non-transitory computer readable media of any of clauses 11-13, wherein performing the one or more operations to generate the encoded video frame comprises selecting a technique for encoding a block within a second frame that is included in the video sequence and corresponds to the second denoised frame based on a cost associated with encoding the block.

15. The one or more non-transitory computer readable media of any of clauses 11-14, wherein the technique comprises adding a random offset to a zero-valued motion vector defined from a first denoised block included in the first denoised frame to a second denoised block associated with the block.

16. The one or more non-transitory computer readable media of any of clauses 11-15, wherein the technique comprises computing a second residual between the block and a corresponding block that is included in the first frame when a zero-valued motion vector is defined from the corresponding block to the block.

17. The one or more non-transitory computer readable media of any of clauses 11-16, wherein the technique comprises predicting the block based on a first block included in the first frame and a second block included in a third frame in the video sequence.

18. The one or more non-transitory computer readable media of any of clauses 11-17, wherein performing the one or more operations to generate the encoded video frame further comprises computing the cost based on a distortion associated with the block and a bitrate associated with the block.

19. The one or more non-transitory computer readable media of any of clauses 11-18, wherein the first frame comprises a reference frame that is a reconstruction of a key frame in the video sequence and the encoded video frame comprises an encoding of a current frame that is included in the video sequence and corresponds to the second denoised frame.

20. In some embodiments, a system comprises a memory that stores instructions, and a processor that is coupled to the memory and, when executing the instructions, is configured to perform one or more operations to generate a plurality of denoised video frames associated with a video sequence, determine a first set of motion vectors based on a first denoised frame included in the plurality of denoised video frames and a second denoised frame included in the plurality of denoised video frames, determine a first residual between the second denoised frame and a prediction frame that is generated based on the first set of motion vectors and the second denoised frame, and perform one or more operations to generate an encoded video frame associated with the second denoised frame based on the first set of motion vectors, the first residual, and a first frame that is included in the video sequence and corresponds to the first denoised frame.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for encoding video frames, the method comprising:
performing one or more operations to generate a plurality of denoised video frames associated with a video sequence;
determining a first set of motion vectors based on a first denoised frame included in the plurality of denoised video frames and a second denoised frame included in the plurality of denoised video frames;
determining a first residual between the second denoised frame and a prediction frame associated with the second denoised frame; and
performing one or more operations to generate an encoded video frame associated with the second denoised frame based on the first set of motion vectors, the first residual, and a first frame that is included in the video sequence and corresponds to the first denoised frame.

2. The computer-implemented method of claim 1, further comprising generating a first reconstructed video frame associated with a second frame that is included in the video sequence and corresponds to the second denoised frame based on the first set of motion vectors, the first residual, and the first frame.

3. The computer-implemented method of claim 2, further comprising generating a second reconstructed video frame associated with a third frame that is included in the video sequence based on the first reconstructed video frame, a second set of motion vectors, and a second residual.

4. The computer-implemented method of claim 2, wherein performing the one or more operations to generate the encoded video frame comprises generating an intra-frame prediction of a block included in the encoded video frame based on one or more adjacent blocks included in the first reconstructed video frame.

5. The computer-implemented method of claim 1, wherein performing the one or more operations to generate the encoded video frame comprises generating an intra-frame prediction of a block included in the encoded video frame based on a first cost associated with the intra-frame prediction and a second cost associated with an inter-frame prediction of the block.

6. The computer-implemented method of claim 1, wherein performing the one or more operations to generate the encoded video frame comprises adding a random or pseudo-random offset to a zero-valued motion vector defined from a first denoised block included in the first denoised frame to a second denoised block included in the second denoised frame.

7. The computer-implemented method of claim 1, wherein the first set of motion vectors includes a zero-valued motion vector defined from a first denoised block included in the first denoised frame to a second denoised block included in the second denoised frame, and further comprising performing one or more operations to generate the encoded video frame based on a second residual between a first block that corresponds to the first denoised block and is included in the first frame and a second block that corresponds to the second denoised block and is included in a second frame that corresponds to the second denoised frame.

8. The computer-implemented method of claim 1, further comprising generating the prediction frame based on the first denoised frame and the first set of motion vectors.

9. The computer-implemented method of claim 1, wherein performing the one or more operations to generate the plurality of denoised video frames comprises:
applying one or more filters to a first reconstructed frame associated with the first frame to generate the first denoised frame; and
applying the one or more filters to a second frame that is adjacent to the first frame within the video sequence to generate the second denoised frame.

10. The computer-implemented method of claim 9, wherein the one or more filters comprise at least one of a low-pass filter, a finite impulse response (FIR) filter, an infinite impulse response (I IR) filter, a nonlinear filter, a content-adaptive filter, or a temporal filter.

11. One or more non-transitory computer readable media storing instructions that, when executed by one or more processors, cause the one or more processors to perform the steps of:
performing one or more operations to generate a plurality of denoised video frames associated with a video sequence;
determining a first set of motion vectors based on a first denoised frame included in the plurality of denoised video frames and a second denoised frame included in the plurality of denoised video frames;
generating a prediction frame based on the first denoised frame and the first set of motion vectors;
determining a first residual between the second denoised frame and the prediction frame; and
performing one or more operations to generate an encoded video frame associated with the second denoised frame based on the first set of motion vectors, the first residual, and a first frame that is included in the video sequence and corresponds to the first denoised frame.

12. The one or more non-transitory computer readable media of claim 11, wherein the instructions further cause the one or more processors to perform the step of generating a first reconstructed video frame associated with a second frame that is included in the video sequence and corresponds to the second denoised frame based on the first set of motion vectors, the first residual, and the first frame.

13. The one or more non-transitory computer readable media of claim 12, wherein the instructions further cause the one or more processors to perform the step of generating an intra-frame prediction of a block included in the encoded video frame based on one or more adjacent blocks included in the second denoised frame.

14. The one or more non-transitory computer readable media of claim 11, wherein performing the one or more operations to generate the encoded video frame comprises selecting a technique for encoding a block within a second frame that is included in the video sequence and corresponds to the second denoised frame based on a cost associated with encoding the block.

15. The one or more non-transitory computer readable media of claim 14, wherein the technique comprises adding a random offset to a zero-valued motion vector defined from a first denoised block included in the first denoised frame to a second denoised block associated with the block.

16. The one or more non-transitory computer readable media of claim 14, wherein the technique comprises computing a second residual between the block and a corresponding block that is included in the first frame when a zero-valued motion vector is defined from the corresponding block to the block.

17. The one or more non-transitory computer readable media of claim 14, wherein the technique comprises predicting the block based on a first block included in the first frame and a second block included in a third frame in the video sequence.

18. The one or more non-transitory computer readable media of claim 14, wherein performing the one or more operations to generate the encoded video frame further comprises computing the cost based on a distortion associated with the block and a bitrate associated with the block.

19. The one or more non-transitory computer readable media of claim 11, wherein the first frame comprises a reference frame that is a reconstruction of a key frame in the video sequence and the encoded video frame comprises an encoding of a current frame that is included in the video sequence and corresponds to the second denoised frame.

20. A system, comprising:
a memory that stores instructions, and
a processor that is coupled to the memory and, when executing the instructions, is configured to:
perform one or more operations to generate a plurality of denoised video frames associated with a video sequence;
determine a first set of motion vectors based on a first denoised frame included in the plurality of denoised video frames and a second denoised frame included in the plurality of denoised video frames;
determine a first residual between the second denoised frame and a prediction frame that is generated based on the first set of motion vectors and the second denoised frame; and
perform one or more operations to generate an encoded video frame associated with the second denoised frame based on the first set of motion vectors, the first residual, and a first frame that is included in the video sequence and corresponds to the first denoised frame.
